(19) United States
(12) Patent Application Publication
(10) Pub. No.: US 2007/0067677 A1
(43) Pub. Date: Mar. 22, 2007

(54) Program-controlled unit and method

(76) Inventors: Reinhard Weiberle, Vaihingen/Enz (DE); Eberhard Boehl, Reutlingen (DE); Thomas Kottke, Ehningen (DE)

Correspondence Address: KENYON & KENYON LLP, ONE BROADWAY, NEW YORK, NY, 10004, US

(21) Appl. No.: 10/553,506

(22) PCT Filed: Apr. 7, 2004
(86) PCT No.: PCT/EP04/50465

§ 371 Date: Nov. 3, 2006

(30) Foreign Application Priority Data
Apr. 17, 2003 (DE) 103 17 650.0

(51) Int. Cl. G06F 11/00

(52) U.S. Cl. 714/25

(57) ABSTRACT

A program-controlled unit includes a single controller core that has a first and at least a second execution unit, which units are operable independently of one another in a first operating mode, and process the same instructions in parallel in a second operating mode.

### FIELD OF THE INVENTION

The present invention relates a program-controlled unit and a method for operating that program-controlled unit.

### BACKGROUND INFORMATION

Program-controlled units are embodied, for example, as microprocessors, microcontrollers, signal processors, or the like. A microcontroller has a microcontroller core, one or more memories (program memory, data memory, etc.), peripheral components (oscillator, I/O ports, timer, A/D converter, D/A converter, communications interfaces) and an interrupt system, which are together integrated on a chip and interconnected via one or more buses (internal, external data/address bus). The construction and manner of operation of a program-controlled unit of this kind are widely known and therefore need not be discussed further in detail.

In the context of a modular microcontroller concept, the microcontroller core is the on-chip integrated central control unit (CPU). It substantially contains a more or less complex control unit, several registers (data register, address register), a bus control unit, and a calculation unit (arithmetic logic unit=ALU) which performs the actual data-processing function. An ALU calculation unit of this kind can usually perform only simple elementary operations involving a maximum of two input data (operands). These operands, as well as the results of the calculation, can be accommodated before and after processing in register or memory locations provided expressly for them. Errors can occur during processing of the operands, however, and can have a disadvantageous effect on the result. Such an error can result from the fact that at least one operand injected into the input side of the ALU becomes corrupted. This can happen, for example, because (the) potential representing the particular input datum is higher or lower than provided for. If this change in charge is great enough, a potential representing one logic state can be changed into a potential representing a different logic state. For example, a potential representing a logical “1” can be changed into a potential representing a logical “0” and vice versa, but this significantly corrupts the result.

With the continuing development of semiconductor process engineering toward smaller dimensions and lower operating voltages, the probability of the above-described types of errors is increasing. For this reason, modern microprocessor systems are equipped with a system for error detection or error recovery, with which system an error that occurs can be identified and displayed (failure identification) and, depending on the functionality of the system, actions can be taken in the event an error occurs. An error correction system of this kind can be provided, for example, by way of an ECC (error checking and correction) system that contributes to the protection of important data. In order to be able to react to errors, modern microcontroller systems are usually equipped with an error detection system based on redundant system functionality. System redundancy can be implemented, for example, by multiple time-offset calculation (temporal redundancy) or by way of additional circuits (hardware redundancy). In the former case, in which an application program is executed several times in chronological succession, sporadic or statistical errors that occur during operation can be detected. This type of redundancy, however, allows only error detection and a limited fail-safe functionality, which moreover is also very time-consuming and thus impairs the performance of the entire system. Error recovery is not possible in this case.

For this reason, error detection systems based on hardware redundancy are predominantly used; in these, the redundant hardware (i.e. present in duplicate) executes the application program in parallel. Published international patent application WO 01/46806 entitled “Firmware Mechanism for Correcting Soft Errors,” which corresponds to published German Patent DE 100 85 324, describes a computer system that has hardware-redundant error detection. The computer system described in WO 01/46806 has two microprocessor cores operable independently of one another, and a comparison unit downstream from the two cores. In a first operating mode (normal mode), instructions and data can be processed in the two cores independently of one another. In a second, so-called lock-step operating mode (test mode), the two cores are operated redundantly, i.e. the same instructions are processed in both cores. The results from the cores operated in redundant mode are compared with one another in the comparison unit in accordance with an error handling routine, and an error signal is generated if they do not agree. This allows the register contents of the cores to be saved. The status of the microprocessor prior to occurrence of the error event can be restored from the data saved in this fashion.

A disadvantage of the approach described in WO 01/46806 is the additional outlay necessary in order to make the redundant system available, especially since in this instance the entire core is provided in duplicate. In particular with very complex microcontrollers that consequently have a complex control unit and a complex bus control unit, the additional chip area required for redundancy is very large. In the case of chip-area-critical microcontroller systems, provision of these chip-area-consuming units is counterproductive, and is becoming increasingly unacceptable to users. For this reason alone, a demand therefore exists for differentiation on the market, as compared with substantially functionally identical competing products, by way of a decrease in chip area and thus a reduction in product costs. This represents a considerable competitive advantage.

With the system described in WO 01/46806, it is furthermore impossible to perform error qualification, so that no determination can be made as to where the error actually occurred. Only error detection takes place. An error can, however, occur at various points in the system; for example, an error can occur on a bus line or because of an erroneous operation within a calculation unit or a comparison unit. A need therefore exists for error qualification.

### SUMMARY

The program-controlled unit according to the present invention and the method according to the present invention have the advantage, as compared with the conventional approaches, of making available simplified error correction that is optimized especially in terms of chip area requirement.

The present invention is based on the recognition that the entire microcontroller core need not be redundant for error recognition. It is instead entirely sufficient if only the execution unit, in which the calculation operations are ultimately performed, is redundant. This type of program-controlled unit with error detection thus makes do with very much less chip area compared with the aforementioned known system, since the provision of a duplicate control unit, bus control unit and registers, which occupy the largest chip area within a microcontroller core, can be dispensed with.

The present invention thus provides to duplicate only the execution unit of the microcontroller core. Fully functional error detection is thus possible, the remaining components of a microcontroller core, e.g. the control unit and bus control unit, being protected by other error detection mechanisms based on error detection or error correction codes. It is thus possible to provide a program-controlled unit, with an error detection device, that makes do with a much smaller chip area than conventional program-controlled units that have, for error detection, a so-called dual-core microcontroller equipped with two microcontroller cores. The chip area of the program-controlled unit according to the present invention, and of its error correction device, is larger than the chip area of so-called single-core program-controlled units, i.e. those that have only one microcontroller core and thus no error detection device. The chip area of the program-controlled unit according to the present invention and its error detection device is, however, significantly reduced as compared with dual-core microcontrollers.

The particular advantage of the method and the system according to the present invention is also that an error can be detected within one clock cycle, and corresponding corrective measures can thus be initiated very quickly. The performance of the system as a whole is thus almost unimpaired.

A further advantage of the present invention lies in the fact that in addition to detection of an error, an error qualification is also possible, i.e. the error location within the program-controlled unit at which the error occurred can be determined.

The program-controlled unit according to the present invention has a first operating mode, hereinafter referred to as normal mode, and a second operating mode, hereinafter referred to as test mode. The program-controlled unit has a single microcontroller core that, however, is equipped with two execution units. “Execution unit” is to be understood as, for example, an arithmetic logic unit (ALU) in which the actual data processing functions are performed. The execution unit is often also referred to as the arithmetic unit or computation unit. In normal mode the two execution units can, but need not necessarily, process instructions in parallel. In test mode, error detection occurs. In test mode, identical instructions are injected in parallel into both execution units. The existence of an error can thus be detected from a comparison of the two results.

Provided for this purpose is an error detection device that, in test mode, performs an error detection and/or error correction. Correction of an error discovered in the execution unit is accomplished, in accordance with an error handling routine (error correction method), by repeating a corresponding instruction. Depending on the nature of the core, shadow registers for the input register are necessary for this purpose.

For error-correction purposes, the error correction device has a coder with which data are equipped with an error detection code and/or an error correction code. Result data, which can be picked off at the output side of the execution units subsequent to calculation, are equipped with the corresponding error detection code or error correction code.

Data injected into the input side of the execution unit are typically not equipped with an error detection code and/or error correction code. All that is done here is to create a checksum of the injected data. This checksum is compared with the checksum stored in the registers, and in the event of a corruption the data are corrected and injected again into the execution unit, but without a checksum.

In a first example embodiment, the error detection device has a first comparison unit that is placed downstream from the two execution units on the output side. This comparison unit compares the result data calculated by the computation units, or the data's error correction coding, in accordance with an error handling routine. In the event an error is detected, i.e. in the event the result data or error correction codings do not agree, this is recognized as an error and an error signal is outputted.

In a further example embodiment, the error detection device has a second comparison unit that is placed upstream from at least one of the execution units on the input side. This comparison unit compares the operands delivered to a respective operating unit, or their error correction coding, in accordance with an error handling routine. If an error is present, i.e. in the event of a discrepancy in the input data or error correction coding compared with one another in the comparison unit, this is interpreted as an error and an error signal is then outputted.

In a further example embodiment, a shared data register is provided that, in test mode, is associated with both execution units. Data that are to be conveyed, for example, via a bus to the execution units can be stored in this shared data register.

In a further example embodiment, a shadow register may be provided in which the input data most recently conveyed to the respective execution units in test mode prior to calculation are stored. In a very simple embodiment, this type of shadow register can be embodied as a simple FIFO (first in first out). This FIFO is advanced, and therefore can be overwritten again, only when the comparison within the comparison units indicates that no error is present.

Advantageously provided for this is a control device that is coupled on the input side to the error detection device and on the output side to the shadow register. If the error detection device recognizes that no error is present, the control device generates an enable signal that enables the shadow register to be overwritten again.

The program-controlled unit according to the present invention may be implemented, for example, as a microcontroller, microprocessor, signal processor, or a control unit configured in other suitable fashion.

In a very advantageous method according to the present invention, the input data, or the calculated result data or their error codings, are compared with one another. If this comparison indicates that the data or codes do not correspond to one another, this is then interpreted as an error and an error signal is generated.

In an advantageous example embodiment, a separate error signal is outputted for each of these errors, so that a localization of the error location is possible based on the error signal. It is thereby possible to distinguish various types of error from one another. In this way, for example, an error occurring as a result of incorrect coding can be distinguished from an error caused by incorrect data injected via the bus lines or one generated within the computation unit. As a result, in very advantageous fashion, error quantification is also possible in addition to error qualification.

In a particularly advantageous example embodiment, the operands injected into the computation units on the input side are first conveyed to both execution units. Only then is a checksum (e.g. parity, CRC, ECC) created from these input data and conveyed to the input-side comparators. The performance of the data processing system is therefore not appreciably impaired by the input-side error correction.

In the method according to the present invention, the stored input data from the last calculation are not overwritten until a comparison within an error detection device indicates that no error is present. This ensures that the data originally injected, and their codes, are not lost even in the event of an incorrect calculation in one of the execution units, or in the event of a coding error.

### BRIEF DESCRIPTION OF THE DRAWINGS

FIG. 1 shows a first functional diagram for illustrating an example embodiment of the program-controlled unit according to the present invention and its operation.

FIG. 2 shows a second functional diagram for illustrating another example embodiment of the program-controlled unit according to the present invention and its operation.

### DETAILED DESCRIPTION

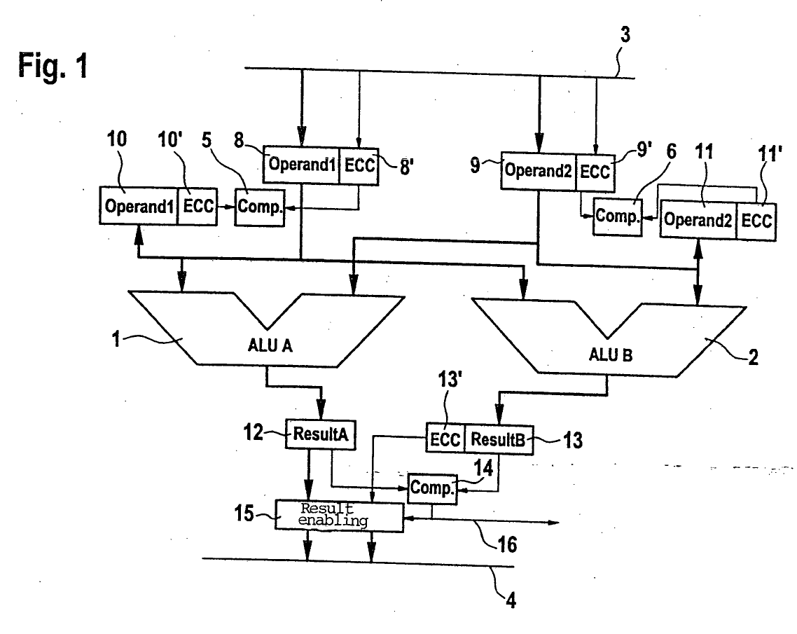

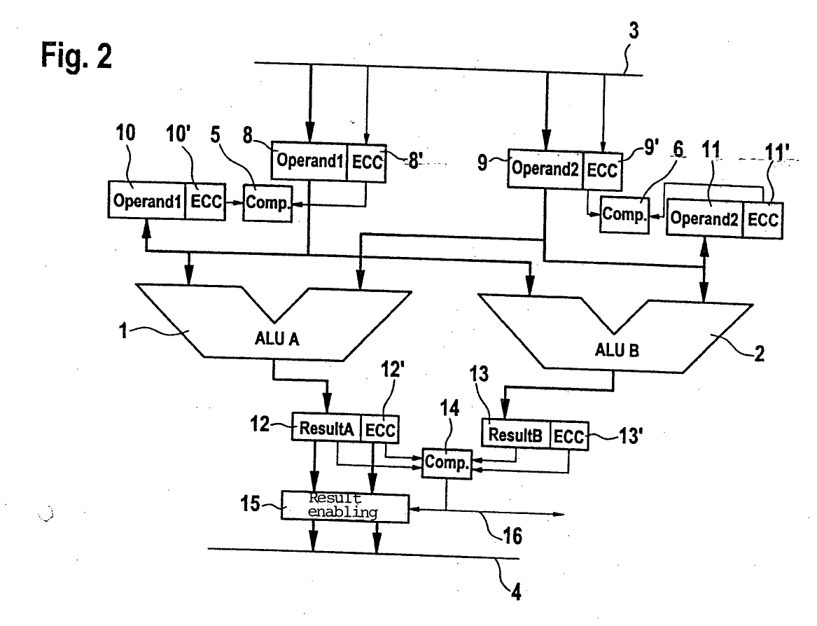

In FIGS. 1 and 2, identical or identically functioning elements have been labeled with identical reference characters unless otherwise indicated. For better clarity, the program-controlled unit according to the present invention, as well as its components such as the microcontroller core (CPU), memory units, peripheral units, etc., are not depicted in FIGS. 1 and 2.

In FIGS. 1 and 2, reference characters 1 and 2 respectively designate arithmetic logic units (ALUs). A respective ALU 1, 2 has two inputs and one output. In a test mode, the operands provided for execution can be injected directly (not depicted) from bus 3 into the inputs of ALUs 1, 2, or can previously be stored in an operand register 8, 9 provided expressly therefor. These operand registers 8, 9 are coupled directly to data bus 3. The two ALUs 1, 2 are therefore supplied from the same operand registers 8, 9. Provision can additionally be made for the respective operands already to be provided, via the bus, with an ECC coding which are stored in register regions 8′, 9′.

In the context of injection of the respective operands into ALUs 1, 2, particular attention must be paid to correct data input. For example, if the same incorrect operands are injected into both ALUs 1, 2, an error at the output of ALUs 1, 2 is not detectable. It must therefore be ensured that at least one of ALUs 1, 2 receives a correct data input value, or even that the two ALUs 1, 2 receive different but incorrect data input values. This is ensured by the fact that a checksum (e.g. parity, CRC, ECC) is created from at least one input value of an ALU 1, 2. In a comparison unit 5, 6 expressly provided, ECC coding 10′, 11′ from these additional data registers 10, 11 is compared with ECC coding 8′, 9′ from the original source register 8, 9. Optionally, the input data from registers 10, 11 can also be compared (not depicted) with those from source registers 8, 9. If a difference is apparent in the ECC coding or in the operands, this is then interpreted as an error and an error signal is outputted.

This comparison may be accomplished during processing of the operands in ALUs 1, 2, so that this input-side error detection and error correction proceeds with almost no performance loss. If one of comparison units 5, 6 detects an error, the calculation can be repeated within the next cycle. The use of a shadow register may be incorporated here so that the operands of the last calculation are always saved, in order to be quickly available again in the event of an error. Provision of a shadow register can be dispensed with, however, if the respective operand registers 10, 11 are overwritten again only by way of an enable signal based on absence of an error. In the event of an error, comparison units 5, 6 furnish an error signal which causes operand registers 10, 11 not to be overwritten.

ALUs 1, 2 each generate a result at the output side. The result data and their ECC codings made available by ALUs 1, 2 are stored in result registers 12, 13, 12′, 13′. These result data and/or their codings are compared with one another in comparison unit 14. In the event an error is not present, an enabling signal 16 is generated. This enabling signal 16 is injected into enabling device 15, which is authorized to write the result data to a bus 4. These result data can then be further processed via bus 4.

Enable signal 16 can furthermore be used to release registers 8-11, so that the next operands can be read out from bus 3 and processed in ALUs 1, 2.

With the system shown in FIG. 1, the result is not checked. Here the result data are simply compared with one another in comparison unit 14. Checking of the ECC codings of the result data is made possible by the system shown in FIG. 2, in which both the result data and their ECC codings are compared with one another in comparison unit 14.

All transient errors, permanent errors, and even runtime errors are detected with the error detection assemblage described in FIGS. 1 and 2. Runtime errors within one ALU 1, 2 are detected if the result arrives too late or not at all at comparison unit 12, and a comparison is thus performed using a partial result. Because operand registers 8, 9, 10, 11 with the error detection and error correction codes are saved, and because the final results are compared, the location and time of the particular error can be precisely localized. A transient fault can therefore be reacted to very quickly.

The following possibilities for error localization thus result:
If a comparison of the result data in comparison unit 14 indicates a difference, an error within one of ALUs 1, 2 can be inferred.
If a comparison of the ECC codes in one of comparison units 5, 6 indicates a difference, an incorrect signal from bus 3 or upstream components can be inferred.
If a comparison of the ECC codes in comparison unit 14 indicates a difference, incorrect coding of the result can be inferred.

Although the present invention has been described above with reference to example embodiments, it is not limited thereto but rather is modifiable in many ways and fashions known to one skilled in the art.

1-15. (canceled)

16. A program-controlled computer unit, comprising:
a single controller core including at least a first execution unit and a second execution unit;
wherein the first and the second execution units are operable independently of one another in a first operating mode, and wherein the first and the second execution units are operable in a second operating mode to process the same set of instructions in parallel.

17. The program-controlled computer unit as recited in claim 16, further comprising:
an error detection device that performs, in the second operating mode, at least one of an error detection and an error correction in accordance with an error handling routine.

18. The program-controlled computer unit as recited in claim 17, wherein the error detection device includes a coder that provides at least one of: a) an error detection code to input data conveyed to the first and the second execution units on the input side; and b) an error correction code to an output signal calculated by at least one of the first and the second execution units.

19. The program-controlled computer unit as recited in claim 18, wherein the error detection device includes a first comparison unit downstream from the first and the second execution units on the output side, and wherein the first comparison unit provides a comparison, in accordance with an error handling routine, for at least one of the following: a) a set of output signals calculated by the first and the second execution units; and b) a set of error correction codes assigned to output signals calculated by the first and the second execution units, whereby it is determined whether an error is present, and wherein an error signal is output in the event an error is present.

20. The program-controlled computer unit as recited in claim 19, wherein the error detection device includes a second comparison unit upstream from at least one of the first and the second execution units on the input side, the second comparison unit comparing input data conveyed to at least one of the first and the second execution units on the input side with input data provided with a checksum, in accordance with an error detection routine, to determine whether an error is present, and wherein an error signal is output in the event an error is present.

21. The program-controlled computer unit as recited in claim 20, further comprising:
at least one data register associated with at least one of the first and the second execution units, wherein the at least one data register is connected on the output side to both the inputs of the first and the second execution units and to the second comparison unit, and wherein input data for at least one of the first and the second execution units are stored in the at least one data register.

22. The program-controlled computer unit as recited in claim 20, further comprising:
a shadow register, wherein input data most recently conveyed to at least one of the first and the second execution units prior to calculation are stored.

23. The program-controlled computer unit as recited in claim 22, wherein the shadow register is a first-in-first-out register.

24. The program-controlled computer unit as recited in claim 22, further comprising:
a control device coupled on the input side to the error detection device and coupled on the output side to the shadow register, wherein the control device generates an enabling signal for enabling the shadow register only if no error is detected by the error detection device.

25. The program-controlled computer unit as recited in claim 24, wherein the program-controlled computer unit is one of a microcontroller and a microprocessor.

26. A method for operating a program-controlled computer unit that includes: a) a single controller core having at least a first execution unit and a second execution unit, wherein the first and the second execution units are operable independently of one another in a first operating mode, and wherein the first and the second execution units are operable in a second operating mode to process the same set of instructions in parallel; and b) an error detection device having at least one comparison unit, the method comprising:
performing, in the second operating mode, at least one of an error detection and an error correction in accordance with an error handling routine using the error detection device, wherein the at least one comparison unit provides a comparison, accordance with an error handling routine, for at least one of the following: a) a set of input data for the first and the second execution units; b) a set of output signals calculated by the first and the second execution units; and c) a set of error correction codes assigned to output signals calculated by the first and the second execution units, and wherein an error signal is generated if the comparison does not produce an agreement.

27. The method as recited in claim 26, wherein different error signals are generated for different types of error.

28. The method as recited in claim 27, wherein the input data are first conveyed to both the first and the second execution units, and subsequently corresponding error correction codes are generated from the input data.

29. The method as recited in claim 28, wherein stored input data of the previous calculation are overwritten only if one of: a) a comparison of the stored input data; and b) a comparison of output result data calculated from the stored input data, does not result in an error signal.

30. The method as recited in claim 29, wherein the output result data calculated from the stored input data are transmitted for only if an error signal is not present.
